(19) United States
(12) Patent Application Publication
(10) Pub. No.: US 2014/0089446 A1
(43) Pub. Date: Mar. 27, 2014

(54) ADVANCED CLOUD COMPUTING DEVICE FOR THE CONTROL OF MEDIA, TELEVISION AND COMMUNICATIONS SERVICES

(71) Applicants: Arun Mallikarjunan, Silver Spring, MD (US); Martin Roy Hannes, Washington, DC (US); Tiffany Ann Wood, Washington, DC (US); Sasha Firsov, Washington, DC (US)

(72) Inventors: Arun Mallikarjunan, Silver Spring, MD (US); Martin Roy Hannes, Washington, DC (US); Tiffany Ann Wood, Washington, DC (US); Sasha Firsov, Washington, DC (US)

(21) Appl. No.: 14/035,902

(22) Filed: Sep. 24, 2013

Related U.S. Application Data
(60) Provisional application No. 61/704,645, filed on Sep. 24, 2012.

(51) Int. Cl. H04L 29/08

(52) U.S. Cl. CPC H04L 67/1097
USPC 709/212

(57) ABSTRACT

The present invention relates generally a system and apparatus for video entertainment. More specifically, embodiments of the present invention provide a system and apparatus for an advanced cloud computing device for the control of media, television and communications services as well as methods related thereto.

### CROSS-REFERENCE TO RELATED APPLICATIONS

This application claims the benefit of provisional patent application, U.S. Pat. App. No. 61/704,645 filed on Sep. 24, 2012, which is hereby incorporated by reference in its entirety.

### FIELD OF THE INVENTION

The present invention relates generally a system and apparatus for video entertainment. More specifically, embodiments of the present invention provide a system and apparatus for an advanced cloud computing device for the control of media, television and communications services as well as methods related thereto.

### BACKGROUND OF THE INVENTION

Presently, there are numerous devices designed to communicate with and control various media systems, such as televisions, digital video recorders (DVRs), audio high-fidelity (HiFi) systems and others. However, there is presently a lack of a single device that is capable of providing cross-platform and universal control and integration with any available system.

Certainly, there are devices which suggest in name that they are universal remote controls, but these devices are generally limited to interacting with a small subset of all available devices, generally comprising those using an infrared or other line of sight communications means.

With the growing number of connected devices, whether it be by line of sight communications means, or any other standard communications means (e.g., Bluetooth, WiFi, near field communication (NFC), IR), it would be advantageous to have a single device or apparatus that would be able to communicate with all such connected devices in order to provide the control of media, television, and other communication services.

Therefore, there is need in the art for a system and apparatus for an advanced cloud computing device for the control of media, television and communications services as well as methods related thereto. These and other features and advantages of the present invention will be explained and will become obvious to one skilled in the art through the summary of the invention that follows.

### SUMMARY OF THE INVENTION

Accordingly, it is an aspect of the present invention to provide a system and apparatus for an advanced cloud computing device for the control of media, television and communications services as well as methods related thereto.

Embodiments of the present invention are unique in that they incorporate a plurality systems, selected from the group comprising Bluetooth and WiFi systems of communication to multiple audio, video and communications devices including but not limited to: smart televisions, network enabled cable and satellite set top boxes (STBs), audio HiFi systems, cell phones, tablets, PC's and any other IP wireless enabled devices.

In certain embodiments, the device has its own CPU and operating system allowing for new applications to be easily added for additional smart functionality. Intelligent learning functionality also allows the device to recognize and communicate with other devices via infrared (IR) and Bluetooth, and register and automatically login to WiFi networks.

In other embodiments, the system is comprised of an application software module configured to work in conjunction with third-party computing devices (e.g., smartphones, tablet PCs) and utilize the integrated hardware of such third-party computing devices to handle relevant data processing and communication elements required by the system (e.g., IO features, communication features, processing features). In this embodiment, the application software module is configured to work with standard off-the-shelf hardware and still be able to affect communication, command and control of network enabled media devices.

The combination of the CMC device and the cloud based systems provide an extremely versatile and unique system for the control and integration of television and media viewing and the integration of multiple forms of communications functionality. This is coupled with artificial intelligence system to provide user and location specific personalization and recommendations and changes to viewing schedules for a specific user.

According to an embodiment of the present invention, a cloud media controller device includes: an application software module, comprising computer-executable code stored in non-volatile memory, a processor, a display element, and one or more input and output means, wherein at least one of said input and output means is a communications means, wherein said application software module, said processor, said processor, and said display element, said one or more input and output means and said communications means, are operably connected and are configured to: receive a command request from a user via one or more of said one or more input and output means; identify said user; transmit, via said communications means, a control command based at least in part on said command request; and affect a change on one or more remote media components, wherein said change is based at least in part on said control command.

According to an embodiment of the present invention, the application software module, said processor, said processor, and said display element, said one or more input and output means and said communications means, are further configured to receive, from one or more cloud based servers via said communications means, an acknowledgement of said change being successfully affected on said one or more remote media components.

According to an embodiment of the present invention, the control command is transmitted to one or more cloud based servers for processing.

According to an embodiment of the present invention, the one or more cloud based servers are configured to: identify the cloud media controller device; retrieve information associated with said user; identify said control command; retrieve information associated with said user and relevant to said control command; and transmit a control signal to said one or more remote media components.

According to an embodiment of the present invention, the one or more cloud based servers are further configured to confirm availability of said one or more remote media components.

According to an embodiment of the present invention, the one or more cloud based servers are further configured to process said information associated with said user and relevant to said control command in such a manner that the processing effects the outcome of the control signal sent to said one or more remote media components.

According to an embodiment of the present invention, a computer implemented system for providing cloud based media control includes: an application software module, comprising computer-executable code stored in non-volatile memory, configured to: receive a command request from a user via an input means; identify said user; transmit a control command based at least in part on said command request; and affect a change on one or more remote media components, wherein said change is based at least in part on said control command.

According to an embodiment of the present invention, a method for providing a cloud media controller includes the steps of: receiving a command request from a user via one or more of said one or more input and output means; identifying said user; transmitting, via a communications means, a control command based at least in part on said command request; and affecting a change on one or more remote media components, wherein said change is based at least in part on said control command.

According to an embodiment of the present invention, the method further includes the step of receiving an acknowledgement of said change being successfully affected on said one or more remote media components.

According to an embodiment of the present invention, the method further includes the step of transmitting said control command to one or more cloud based servers for processing.

According to an embodiment of the present invention, the method further includes the steps of having said one or more cloud based servers: identify the cloud media controller device; retrieve information associated with said user; identify said control command; retrieve information associated with said user and relevant to said control command; and transmit a control signal to said one or more remote media components.

According to an embodiment of the present invention, the method further includes the steps of having said one or more cloud based servers confirm availability of said one or more remote media components.

According to an embodiment of the present invention, the method further includes the steps of having said one or more cloud based servers process said information associated with said user and relevant to said control command in such a manner that the processing effects the outcome of the control signal sent to said one or more remote media components.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 is a diagram of a Cloud Media Controller, in accordance with an embodiment of the present invention;

FIG. 2 is a diagram of a Cloud Media Controller and Communications Systems, in accordance with an embodiment of the present invention;

FIG. 3 is a process flow diagram showing an exemplary method in accordance with an embodiment of the present invention; and

FIG. 4 is a process flow diagram showing an exemplary method in accordance with an embodiment of the present invention.

### DETAIL DESCRIPTIONS OF THE INVENTION

The advanced cloud media controller device (CMC) is an intelligent web enabled device for control of all types of media and video (including television) systems that links to “cloud computing” servers for information, updates, scheduling and communications services.

A better understanding of the disclosed embodiments will be obtained from the following detailed descriptions and accompanying illustration. All illustrations of the drawings are for the purpose of describing selected versions of the present invention and are not intended to limit the scope of the present invention.

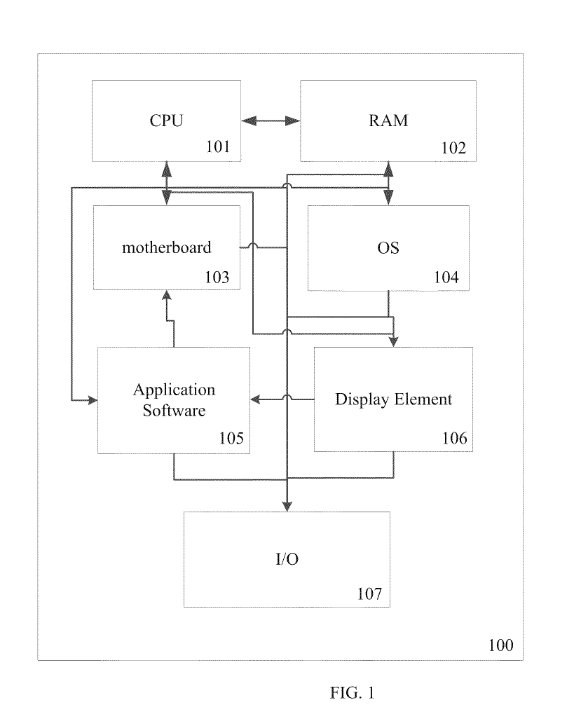

Turning now to FIG. 1, an exemplary embodiment of a cloud media controller, in accordance with an embodiment of the present invention, is shown. According to an embodiment of the present invention, the device incorporates one or more of a processing unit 101, motherboard 103 with RAM memory 102 and OS 104 as well as application software 105 for providing functionality and command information, a display element 106 (e.g., color LCD display with touch screen capabilities, IPS display, LED display, retina display), and one or more input/output means 107 (e.g., keyboard, various input/output ports for Ethernet, firewire, USB, HDMI, wireless connection means). Embodiments of the device may also incorporate one or more of a microphone and/or conference speaker which can be used for simultaneous communications through Bluetooth or other communications means via a connection to a cell phone, smartphone, data connection, VoIP/SIP communications or other communication means through one or more cloud based network servers.

In certain embodiments, the cloud media controller can be linked directly to a Personal Computer (PC), Smart TV or other computing device (e.g., cell phones, smartphones, tablet PCs, set top boxes (STB)), and utilizes one or more communications and networking means (e.g., WiFi, Ethernet, Bluetooth) in order to receive and transmit updates and information. Preferred embodiments of the cloud media controller are battery powered, utilizing one or more rechargeable battery sources that can be charged via one or more power adapter means, such as a power cord, USB connection or inductive charging means (e.g., Qi charging). One of ordinary skill in the art would appreciate that there are numerous types of power adapter means that could be utilized with embodiments of the present invention and embodiments of the present invention are contemplated for use with any appropriate power adapter means.

According to an embodiment of the present invention, utilization of an operating system on the cloud media controller enables the device to add various applications for special advanced television viewing features and communications. Addition of applications may be done by way of downloading or otherwise receiving application data/content from a communication means via one or more networks. In a preferred embodiment of the present invention, the device may connect to a cloud server in order to locate and download one or more additional applications to the device to enhance such functionality.

When the cloud media controller (CMC) device is first connected to a WiFi/Ethernet network it is automatically directed to a network server which authenticates and registers the CMC device and goes through a procedure to set-up the CMC device in order to associate the CMC device with a user. This procedure may include automatically identifying a location to associate with the user and setting up specific usage parameters for one or more users. The identification of a location may be done in one or more well-known means, such as IP addressing, entrance of the location by the user or by determining a location via a global positioning system (GPS) or other location based service (LBS). In certain embodiments GPS or other LBS service may be provided by components of the CMC device or via a third-party device (e.g., Bluetooth connection to a smartphone with GPS capability).

In a preferred embodiment of the present invention, the CMC device supports multiple user profiles so that different users can use the same physical CMC device. A user profile feature allows each user to customize functionality of the CMC device to reflect his or her own personal interests.

In certain embodiments of the present invention, artificial intelligence logic in the CMC device and cloud servers to which the CMC device connects to over one or more networks can make viewing changes and/or viewing recommendations as required based on factors including personal usage history, preferences, location, access to content services (e.g., cable provider, internet provider, services to which the user is a member and has access to via one or more means) and time of day or day of week.

In a preferred embodiment of the present invention, the CMC device incorporates a real-time program guide which is up-dated automatically according to user locations, profiles and interests, as well as the content services available.

According to an embodiment of the present invention, the CMC device also has various automated functions through which it can change or modify viewing options, add additional information or viewing screens and devices as required by the user or set up in the user's on-line schedule. For example, the user can set up specific viewing schedules of choice such that the user will be prompted on a screen controlled by the CMC device (e.g., TV, Monitor) that a scheduled viewing event is coming up and the device will automatically change the viewing channel to that selected program at the scheduled time.

In other embodiments, the CMC device may include a scan and search function which can rapidly scan and preview selected types of programming (showing these options on the television screen) based on search criteria inputted by the user or alternatively based on user profiles and prior viewing histories stored on the cloud servers (e.g., genre favorites, listing includes favorite actor/actress, channel favorites). Advanced search options utilizing aspects of the artificial intelligence system can be applied by the user to enhance the search. For example, a user watching a football game may utilize the scan feature of the CMC device to scan and watch other football games concurrently running Advantageously, when a commercial or other broadcast interruption occurs, or for any other reason, a user can quickly switch between shows of similar types.

In certain embodiments, the scan feature may be configured to allow the user to view more than one viewing option at a time. For instance, the scan feature may be configured to allow one or more Picture-in-a-Picture (PIP) boxes to be presented, with each PIP having a program option for the user to select from. The user could then select one of the PIPs, such as via interaction with the CMC device, in order to bring the PIP box to the main screen. In certain embodiments, the previously viewed program may be moved to the PIP which was occupied by the now main screen program. In other embodiments, after selecting a PIP, all the other PIPs may be configured to disappear until the user utilizes the scan feature again.

In other embodiments, the scan feature may be configured to cycle through program options, such as viewing each available program option

According to an embodiment of the present invention, the CMC device is connected to a communications server which is remote from the user and/or the user's network (i.e., cloud-based) which allows for voice and text connections to other linked users and separately allows a user to make standard telephone calls via interfaces to the traditional POTS networks to landline and cellular telephones as required.

Notifications of messages received or incoming telephone calls may appear on one or more of the device and any connected television or other display device. An incoming telephone call can be answered on the television screen (or other linked devices) as well as on the CMC device.

In certain embodiments, voice response software may be incorporated into the CMC device and, in conjunction with the cloud servers, allow the CMC device to react to voice commands to make changes to the viewing system (i.e. change channels or TV volumes) and respond directly to questions. It can also make voice announcements, pre-empt alarms and provide notifications.

The CMC device can also be managed and administered remotely and the operating system software upgraded either by connecting the device to a computer or OTA (over the air). In addition, the application software on the CMC device may be configured to automatically update itself as triggered by the system servers in the cloud. In other embodiments, updates may be manually processed by the user through interaction with the CMC device.

The preferred embodiment of the present invention comprises a user device (CMC device) and one or more linked cloud based web server systems. The CMC device will typically operate as a stand-alone component in a home media/television environment. However, other embodiments of the system can include the incorporation of the device into another piece of equipment such as a DVR, cable/satellite set top box, Smart TV, Smartphone or tablet, with the same functionality of the standalone device. For instance, the CMC device could be configured to be an application integrated onto a smartphone or a tablet PC and utilize elements already present in the smartphone or tablet PC (e.g., processor, memory, OS, communications means) to provide the hardware components and network connectivity required to operate the CMC device functionality when integrated as an application.

Once connected to the web and cloud web servers, the CMC device can control other associated devices such as televisions and receive information from the internet servers. This information is displayed on the LCD screen on the device and or on the television associated with the CMC. In one embodiment, connections to the other associated devices may be maintained through the cloud web servers, providing an “always on state” or similar in that the cloud web servers can quickly connect to the associated devices, allowing for the CMC device to instantly access and control multiple connected associated devices. In another embodiment, connections can be made via the CMC device, such as through its various IO means. In still further embodiments, the CMC device can utilize a combination of the aforementioned connections, with some devices being connected via the cloud web servers and others being connected via the CMC device's various IO means.

In certain embodiments, the CMC device can function as a standard remote control unit or as an automated advanced control in which case it will receive preferred programming options from the controlling server and allow the user to choose among these options then automatically change the television to that program.

Based on the choice of channel (program) the device will automatically download information on that show which will be displayed on the LCD screen on the device and or television as required. Additional information can be requested via special buttons on the CMC device or via one or more of the IO means in conjunction or independently from the display element.

Functionality can be personalized via connection to one or more cloud servers and/or one or more home web servers to present targeted information and advertising to the user. (An example of this would be the provision of specific programming choices and recommendations for television viewing or eCommerce purchases via the display element or remote viewing screen such as a monitor or television).

As the CMC device is used over time, history of usage is analyzed to develop user specific profiles which then are utilized to make predictive suggestions and recommendations for programming content (TV shows, etc) to augment or replace initial user stored profiles. This can be associated with time of day, day of week, and other parameters such as local events and weather conditions to develop more accurate profiles for the individual's viewing or listening habits.

The linked server system in the cloud pushes information to the CMC device for scheduling of viewing from an on-line program guide. The CMC device can then automatically change to the desired channel at the appropriate time with or without user inputs.

The CMC system has the option of providing alarms based on the criteria that the user defines dependent on the individual devices that are running at any point in time. Alarms can include, but is not limited to, alerts to a PC, wireless telephone or any other connected device via specific device applications. In certain embodiments, the CMC device can also vibrate or emit an audible sound to alert the user of an alarm.

Other linked devices such as cell phones, smartphones, and tablet PCs can also be used as inputs to operate any of the related functionality of the CMC device, and for instance, incoming cell phone calls can be answered via the CMC device with notifications and caller ID via the television screen or other display element as required or configured.

The CMC device can also act as a stand-alone voice communications or messaging device with other users on the same network or more generally via an interface to standard (POTS) telephone networks to landline and mobile devices.

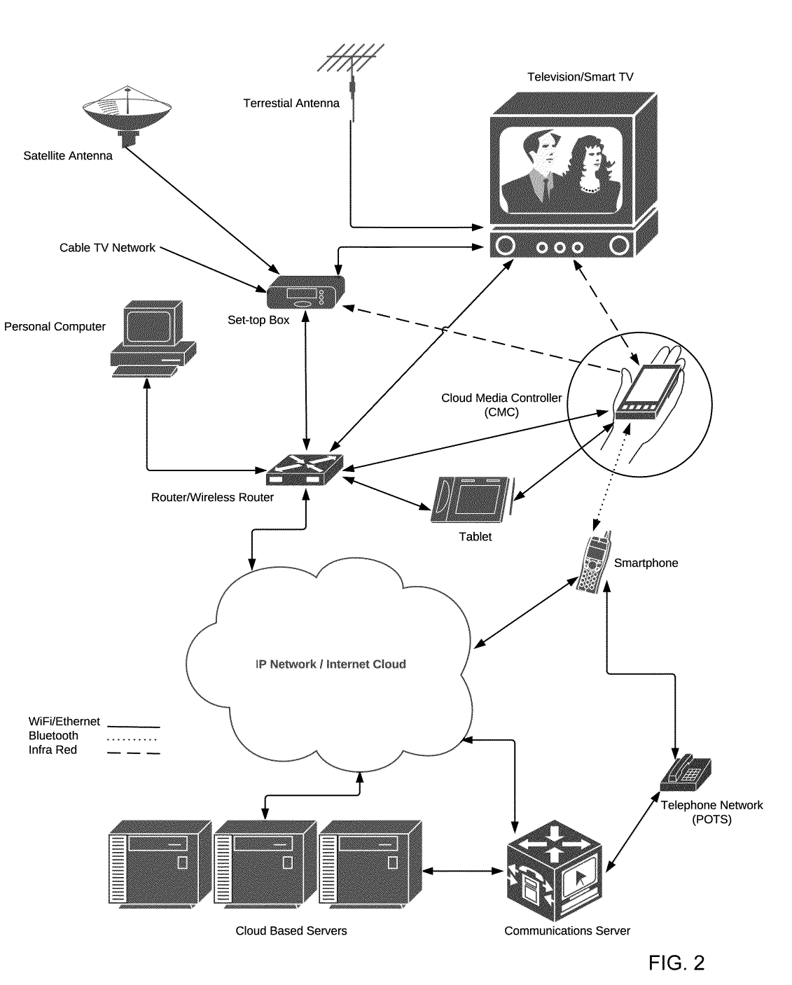

Turning now to FIG. 2, a preferred characterization of the system, in accordance with an embodiment of the standard form of the invention, is shown. FIG. 2 includes key elements of the device and cloud server system including a Cloud Media Controller device. One of ordinary skill in the art would appreciate that certain embodiments may require fewer or additional components to operate, and embodiments of the present invention are contemplated for use with any combination of components.

In a preferred embodiment of the present invention, the Cloud Media Controller Device, as show in FIG. 2, comprises one or more of:

a) a user interface and one or more LCD touch-screens with color display;

b) a user input keyboard with special function keys;

c) an operating System software on device specific central processing unit CMOS/chip;

d) one or more software systems configured to identify connected device types (e.g., TVs, STBs, other auxiliary devices) against standard device profiles;

e) a device application component to control and up-date functionality;

f) an auto learning component to remember new device types and IR commands;

g) a WiFi network interface to internet and cloud based servers; and

h) one or more of a WiFi, a Bluetooth, an audio input and an output connection on the CMC device.

In a preferred embodiment of the present invention, the Cloud Network System components, as shown in FIG. 2, comprises one or more of:

i) a user web portal and interface for account administration and setting of user parameters;

j) one or more cloud based servers with integration systems for the device;

k) one or more linked communications servers interfaced with SMS and POTS telephone networks;

l) one or more linked database systems for storage of user and device information;

m) one or more artificial intelligence systems;

n) one or more data analysis components to analyze and provide recommendations to the user; and

o) one or more voice response system components.

### Exemplary Embodiments

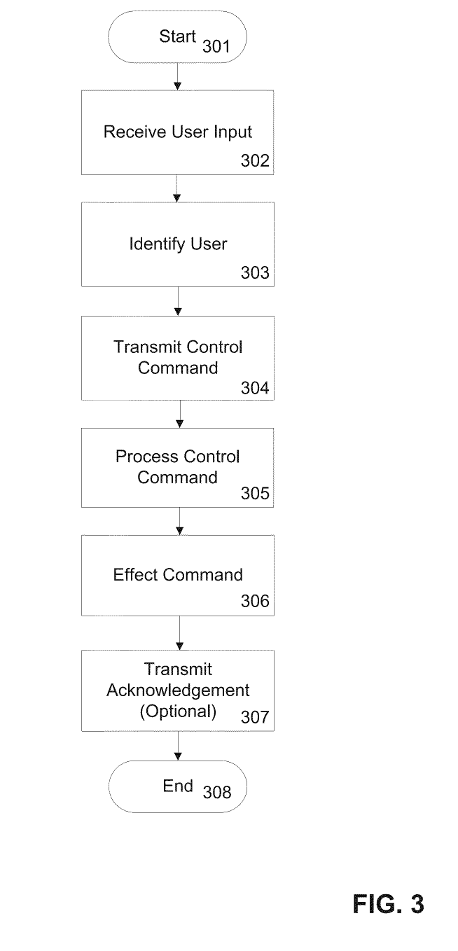

Turning now to FIG. 3, an exemplary method for utilizing the CMC device to effect a command is shown. At step 301, the process starts with a user engaging the CMC device to effect some change on their media systems (e.g., change channel, scan, search). At step 302, the CMC device receives input from the user related to effecting the change to the media system. This may be way of interaction with one or more of the IO devices, such as a touchscreen on the device itself.

At step 303, the CMC device identifies the user submitting the command. In certain embodiments, identification of the user may be done locally, such as by interacting with components of the CMC device in order to identify the user (e.g., via login information, via device utilized). In other embodiments, the CMC device may work in conjunction with the cloud based servers to process identification of users, such as by sending a login request or user identification retrieval request (e.g., via token, via cookie, via login). One of ordinary skill in the art would appreciate that there are numerous methods for identifying a user, and embodiments of the present invention are contemplated for use with any appropriate method for identifying users.

At step 304, the CMC device transmits the control command to the appropriate device or system component. For instance, if the control command is a simple command, such as changing a TV channel, the CMC device may transmit the control command to the appropriate TV (i.e., identified by the user) in a format appropriate for that TV. Since the CMC device will have been previously configured for the TV, the CMC device will know what format the TV will expect.

For more complex commands, the CMC device may be configured to transmit the command to one or more of the cloud servers for processing and additional input (step 305). Complex commands may include, for instance, the scanning of one or more available program listings for content similar to content identified by the user (e.g., currently watched content, searched content, criterion based content). Complex commands may require the system to process one or more logins, third-party service connections or otherwise use relevant information (e.g., location, content service provider information) to process the control command. In preferred embodiments, the system will have been configured, at least in part, before processing control commands, as to allow the system to effect the processing of the command. Configuration may include, but is not limited to, entering of login information, configuring connected devices with the system or any other relevant information required by the system to effect the processing complex commands.

At step 306, the system affects the command by transmitting or otherwise controlling the relevant device in accordance with the desired command. For instance, the system may be configured to present multiple PIP boxes on a main display screen (e.g., TV) related to content currently running on the main display screen, where each of the PIP boxes contains content identified as similar in one or more regards with the content currently running on the main display screen.

At step 307, the system may be optionally configured to transmit and/or display an acknowledgement that the command has been processed and affected. For instance, the system may display on the display element of the CMC device a confirmation that the command has been successfully received and processed. At step 308, the process ends.

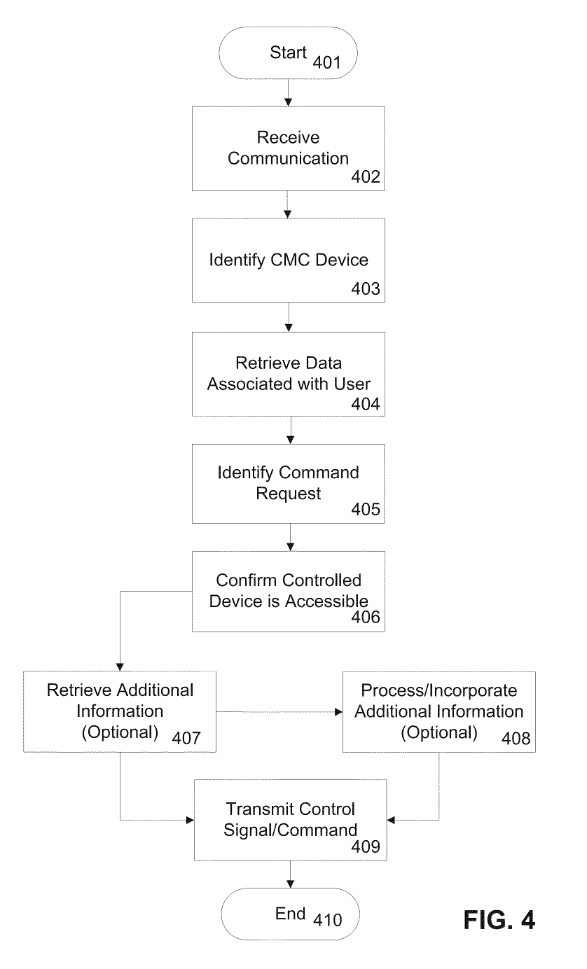

Turning now to FIG. 4, an exemplary method showing utilization of the cloud based servers is shown. At step 401, the process starts with a user desiring to interact with the cloud based servers, generally by way of utilization of a CMC device. At step 402, the one or more cloud based servers receive the control communication from the user. This communication could be received via any number of networks or methods, as described and detailed herein.

At step 403, the system identifies the CMC device, or in certain embodiments simply a user associated with an account, related to the communication. The identification could be done by any number of well-known means, such as via tokens, cookies, login information or any other appropriate means.

Once the user has been identified, the system retrieves information related to the associated user (step 404). Information may be retrieved, for instance, from one or more databases or data stores designed to retain user information and information about services and content providers associated with or otherwise utilized by the user.

At step 405, the system identifies the nature and type of command request received from the user. A command request should include enough information for the system to be able to process and affect the command desired by the user. The more complex the command, the more information may be required to process and affect the command.

At step 406, the system confirms the device upon which the user wishes to affect a command is accessible. Since the system may be configured to have connections with one or more devices, via one or more communications means, the system may select a desired communication method (e.g., via IP address, via MAC address, via secure tunnel connection) and check the status of the device. In other embodiments, the system may simply send a processed command without confirming availability of the device (advance to step 409). This may be preferred when communicating with “dumb” devices or devices lacking two way communications (i.e., devices which only receive, but not transmit, information).

At step 407, if the system identifies the device as available, the system may retrieve additional information required to process and affect the command request. This step is optional, and if the command request is a simple request (e.g., change volume), no additional information may be needed. However, if the command request is complex (e.g., search, scan), the system may need to retrieve information from one or more remote sources (e.g., current TV channel from TV or STB, content providers available, time, location). If no additional information is found, the system may move to step 409. If additional information is found, that information is processed and incorporated into the execution of the command request (step 408).

At step 409, the system affects the execution of the command request, generally by way of transmitting a control signal to one or more devices in order to effect the desired change by the user. After the control signal has been sent, the process ends at step 410.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

According to an embodiment of the present invention, a data store may be comprised of one or more of a database, file storage system, relational data storage system or any other data system or structure configured to store data, preferably in a relational manner. In a preferred embodiment of the present invention, the data store may be a relational database, working in conjunction with a relational database management system (RDBMS) for receiving, processing and storing data. In the preferred embodiment, the data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, HTML, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A cloud media controller device, the device comprising:
an application software module, comprising computer-executable code stored in non-volatile memory,
a processor,
a display element, and
one or more input and output means, wherein at least one of said input and output means is a communications means,
wherein said application software module, said processor, said processor, and said display element, said one or more input and output means and said communications means, are operably connected and are configured to:
receive a command request from a user via one or more of said one or more input and output means;
identify said user;
transmit, via said communications means, a control command based at least in part on said command request; and
affect a change on one or more remote media components, wherein said change is based at least in part on said control command.

2. The cloud media controller device of claim 1, wherein said application software module, said processor, said processor, and said display element, said one or more input and output means and said communications means, are further configured to receive, from one or more cloud based servers via said communications means, an acknowledgement of said change being successfully affected on said one or more remote media components.

3. The cloud media controller device of claim 1, wherein said control command is transmitted to one or more cloud based servers for processing.

4. The cloud media controller device of claim 3, wherein said one or more cloud based servers are configured to:
identify the cloud media controller device;
retrieve information associated with said user;
identify said control command;
retrieve information associated with said user and relevant to said control command; and
transmit a control signal to said one or more remote media components.

5. The cloud media controller device of claim 4, wherein said one or more cloud based servers are further configured to confirm availability of said one or more remote media components.

6. The cloud media controller device of claim 4, wherein said one or more cloud based servers are further configured to process said information associated with said user and relevant to said control command in such a manner that the processing effects the outcome of the control signal sent to said one or more remote media components.

7. A computer implemented system, said system comprising:
an application software module, comprising computer-executable code stored in non-volatile memory, configured to:
receive a command request from a user via an input means;
identify said user;
transmit a control command based at least in part on said command request; and
affect a change on one or more remote media components, wherein said change is based at least in part on said control command.

8. The system of claim 7, wherein said application software module is further configured to receive an acknowledgement of said change being successfully affected on said one or more remote media components.

9. The system of claim 7, wherein said control command is transmitted to one or more cloud based servers for processing.

10. The system of claim 9, wherein said one or more cloud based servers are configured to:
identify the cloud media controller device;
retrieve information associated with said user;
identify said control command;
retrieve information associated with said user and relevant to said control command; and
transmit a control signal to said one or more remote media components.

11. The system of claim 10, wherein said one or more cloud based servers are further configured to confirm availability of said one or more remote media components.

12. The system of claim 10, wherein said one or more cloud based servers are further configured to process said information associated with said user and relevant to said control command in such a manner that the processing effects the outcome of the control signal sent to said one or more remote media components.

13. A method for providing a cloud media controller, the method comprising the steps of:
receiving a command request from a user via one or more of said one or more input and output means;
identifying said user;
transmitting, via a communications means, a control command based at least in part on said command request; and
affecting a change on one or more remote media components, wherein said change is based at least in part on said control command.

14. The method of claim 13, further comprising the step of receiving an acknowledgement of said change being successfully affected on said one or more remote media components.

15. The method of claim 13, further comprising the step of transmitting said control command to one or more cloud based servers for processing.

16. The method of claim 15, wherein said one or more cloud based servers are configured to:
identify the cloud media controller device;
retrieve information associated with said user;
identify said control command;
retrieve information associated with said user and relevant to said control command; and
transmit a control signal to said one or more remote media components.

17. The method of claim 16, wherein said one or more cloud based servers are further configured to confirm availability of said one or more remote media components.

18. The method of claim 16, wherein said one or more cloud based servers are further configured to process said information associated with said user and relevant to said control command in such a manner that the processing effects the outcome of the control signal sent to said one or more remote media components.
